(19) United States
(12) Patent Application Publication
(10) Pub. No.: US 2021/0187610 A1
(43) Pub. Date: Jun. 24, 2021

(54) METAL THREE-DIMENSIONAL PRINTING METHOD WITH VARIABLE SINTERING THERMAL ENERGY

(71) Applicant: NATIONAL CHENG KUNG UNIVERSITY, Tainan City (TW)

(72) Inventor: Yeau-Ren JENG, Tainan City (TW)

(73) Assignee: NATIONAL CHENG KUNG UNIVERSITY, Tainan City (TW)

(21) Appl. No.: 17/091,321

(22) Filed: Nov. 6, 2020

(30) Foreign Application Priority Data
Dec. 19, 2019 (TW) 108146701

(51) Int. Cl. B22F 3/10; B22F 3/105; B33Y 10/00; B23K 26/342; B23K 26/12; B23K 26/14; B23K 26/70

(52) U.S. Cl. CPC B22F 3/1007; B22F 3/1055; B33Y 10/00; B23K 26/342; B23K 26/1462; B23K 26/127; B23K 26/1437; B23K 26/703; B23K 26/123

(57) ABSTRACT

A metal three-dimensional printing method includes steps of: A) laying a layer of metal powder in a chamber, and the chamber having a first gas filled therein; B) projecting a laser on the layer of metal powder along a predetermined path, thereby allowing the metal powder in a projected area to be melted and sintered for shape forming, applying a second gas at a predetermined flow rate on a surface of the metal powder in the projected area, and preventing the metal powder in the projected area from moving due to application of the second gas; wherein the second gas allows the metal powder being projected to be cooled; C) during projection of the laser, a cooling level of the metal powder being projected is changed by changing a flow rate of the second gas, thereby changing a sintering power of the metal powder.

### BACKGROUND OF THE INVENTION

### Technical Field

The present disclosure relates to metal three-dimensional printing technology and, more particularly, to a metal three-dimensional printing method with variable sintering thermal energy.

### 2. Description of the Related Art

Taiwan patent 1634982 discloses a metal three-dimensional printing method for performing metal three-dimensional printing. The method involves projecting a laser on metal powder, such that the metal powder is melted and condensed to integrally take on an intended shape and thus forms a printout in accordance with an outline path. Taiwan patent 1634982 attempts to address an issue: the mechanical properties of the printout are jeopardized by holes and gaps formed therein because of vapor generated at a high temperature near the boiling point of the metal when metal powder is irradiated with the laser. Table 1 in the patent specification of Taiwan patent 1634982 discloses data pertaining to structural strength of printouts formed in the presence of various gases in a container under different pressures, at different temperatures and for different time periods. However, Taiwan patent 1634982 does not disclose changing a power of the laser being projected on the metal powder as needed during the 3D printing process.

EP 3,372,328 A2 discloses technology of metal additive manufacturing (3D printing) with grain size control and essentially involves changing metallic grain size during an additive manufacturing process by changing laser power so as to attain two grain sizes in a printout. Since mechanical properties of an alloy depend on metallic grain size in the alloy, large metallic grains reduce grain surface energy and enhance ductility and malleability, whereas small metallic grains enhance resistance to fatigue and enhance structural strength. Thus, EP 3,372,328 A2 discloses forming a printout which contains metallic grains of different sizes as needed. However, laser sources with a variable power are disadvantaged by overly high unit prices and thus are not favored by manufacturers. Therefore, the prior art still has room for improvement in terms of using one single power laser source and yet being able to change a power of a laser being projected on metallic grains.

### BRIEF SUMMARY OF THE INVENTION

It is an objective of the present disclosure to provide a metal three-dimensional printing method with variable sintering thermal energy, so as to change thermal energy of a laser being projected on a metal powder layer by changing a flow rate of a gas flowing through a laser projected area and thus perform metal three-dimensional printing with variable sintering thermal energy. Therefore, the present disclosure is applicable to one single power laser source.

In order to achieve the above and other objectives, the present disclosure provides a metal three-dimensional printing method with variable sintering thermal energy, comprising the steps of: A) lay a layer of metal powder in a chamber, and the chamber having a first gas filled therein; B) project a laser on the layer of metal powder along a predetermined path, thereby allowing the metal powder in a projected area to be melted and sintered for shape forming, apply a second gas at a predetermined flow rate on a surface of the metal powder in the projected area, and prevent the metal powder in the projected area from moving due to application of the second gas, wherein the second gas applied allows the metal powder being projected to be cooled; C) during projection of the laser along the predetermined path, a cooling level of the metal powder being projected is changed by changing a flow rate of the second gas, thereby changing a sintering power of the metal powder.

Therefore, the present disclosure changes thermal energy of a laser being projected on a metal powder layer by changing a flow rate of a gas flowing through a laser projected area and thus performs metal three-dimensional printing with variable sintering thermal energy. Therefore, the present disclosure is applicable to one single power laser source and yet is effective in changing sintering thermal energy.

### BRIEF DESCRIPTION OF THE SEVERAL VIEWS OF THE DRAWINGS

FIG. 1 is a schematic view of operation of a preferred embodiment of the present disclosure.

FIG. 2 is a perspective view based on FIG. 1.

FIG. 3 is another schematic view of operation of a preferred embodiment of the present disclosure.

### DETAILED DESCRIPTION OF THE INVENTION

Technical features of the present disclosure are hereunder illustrated with preferred embodiments, depicted with drawings, and described below.

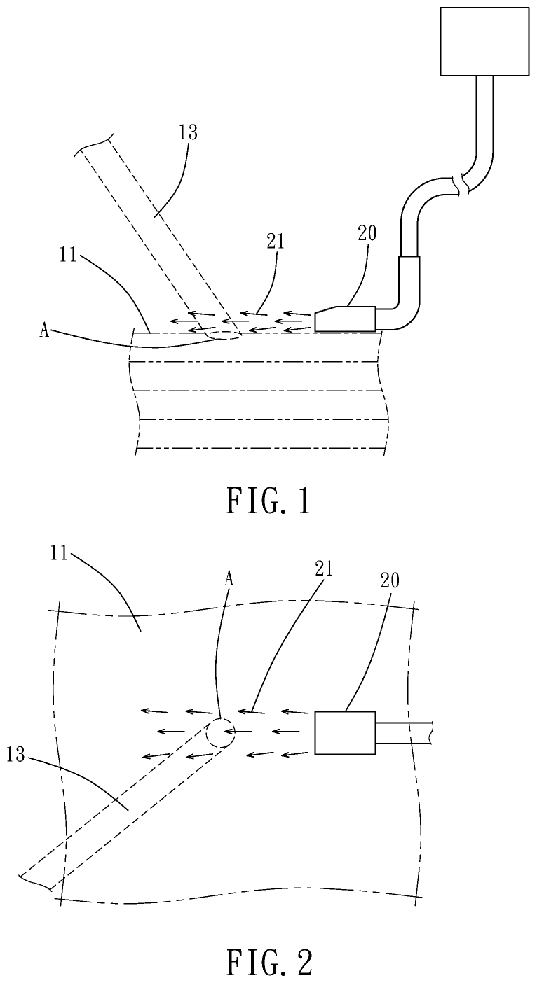

Referring to FIG. 1 and FIG. 2, a metal three-dimensional printing method with variable sintering thermal energy is provided according to a preferred embodiment of the present disclosure, comprising the steps of:

A) lay a layer of metal powder 11 in a chamber (not shown), and the chamber having a first gas filled therein. Preferably, the first gas is a gas which cannot be oxidized, such as argon gas or nitrogen gas. The chamber and the first gas are examples of well-known knowledge regarding metal three-dimensional printing and thus are not shown in the accompanying diagrams, because they are comprehensible without explanations.

B) project a laser 13 on the layer of metal powder 11 along a predetermined path, thereby allowing the metal powder 11 in a projected area A to be melted and sintered for shape forming, apply a second gas 21 at a predetermined flow rate on a surface of the metal powder 11 in the projected area A, and prevent the metal powder 11 in the projected area A from moving due to application of the second gas 21. The second gas 21 applied allows the metal powder 11 being projected to be cooled. Thus, the predetermined flow rate ranges from the least, i.e., no (zero) flow rate to the highest possible flow rate unable for the layer of metal powder 11 to be fluttered. The weight of the metal powder 11 varies with its material particle size and metal type, which affects the configuration of the highest flow rate of the second gas 21; thus, the highest flow rate of the second gas 21 must be configured as needed.

C) during projection of the laser 13 along the predetermined path, a cooling level of the metal powder 11 being projected is changed by changing a flow rate of the second gas 21, thereby changing a sintering power of the metal powder 11. In this step, the amount of the second gas passing through the projected area A per unit time depends on the flow rate of the second gas 21, and thus the cooling level of the metal powder 11 depends on the flow rate of the second gas 21. Therefore, when the laser 13 of the same power is projected on the metal powder 11, its thermal energy is affected by the flow rate of the second gas 21. In this regard, the sintering thermal energy of the laser 13 being projected on the metal powder 11 can be adjusted by adjusting the flow rate of the second gas 21. In this embodiment, the first gas is the same as the second gas 21 and thus is exemplified by argon gas or nitrogen gas. Preferably, the first gas and the second gas 21 are inert gases. The adjustment of the flow rate of the second gas 21 is achieved by directly adjusting a gas source of the second gas 21. Alternatively, two different gas sources each provide the second gas 21 to thereby achieve a difference in the flow rate of the second gas 21 between the two gas sources.

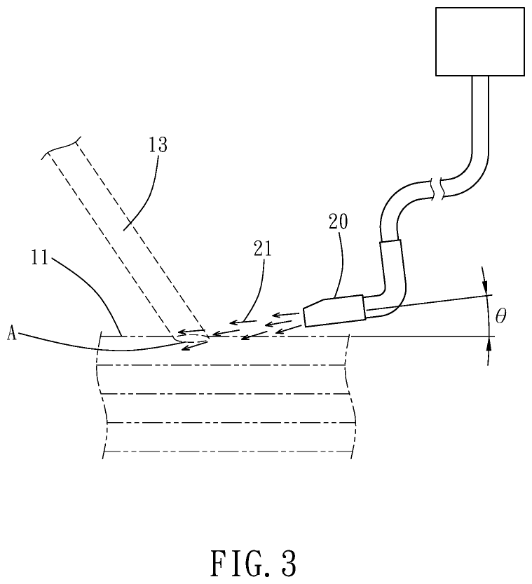

As shown in FIG. 3, in step B, the sintering thermal energy of the laser 13 being projected on the metal powder 11 depends on the angle at which the second gas 21 is applied on the metal powder 11. Thus, in practice, step B entails applying the second gas 21 at a predetermined angle θ which is preferably 0-45 degrees. The larger the angle is, the more likely the metal powder 11 is to be fluttered; thus, a small angle is conducive to reduction of the chance that the metal powder 11 will be fluttered. The predetermined angle is subject to changes as needed. A change in the angle of application of the second gas 21 at the same flow rate thereof causes a change of the amount of the second gas 21 passing through the projected area A per unit time, which in turn changes the sintering thermal energy of the laser 13 being projected on the metal powder 11.

In step B, the sintering thermal energy of the laser 13 being projected on the metal powder 11 also depends on the temperature of the second gas 21 applied. Thus, in practice, step B entails applying the second gas 21 at a predetermined temperature, with the predetermined temperature set to the current room temperature or to a lower or higher temperature, as needed. Furthermore, the sintering thermal energy can be changed by changing the temperature at which the second gas 21 is applied or the temperature of the second gas 21. When determining the temperature of the second gas, considerations should be given to whether the temperature thus determined will affect the sintered, shaped grains, will prevent the induction of grain coarsening or refining, and will prevent cracks, holes and gaps which might otherwise be caused by excessive thermal expansion and contraction.

As shown in FIG. 2, in step B, the second gas 21 to be applied is ejected from a nozzle 20, and the discharge hole of the nozzle 20 is of a greater width than the projected area A. This design ensures that the second gas 21 can have full and complete effect on the projected area A when applied thereto.

The present disclosure has advantages as follows: in addition to the first gas in the chamber, the second gas 21 is provided and applied on the metal powder 11 in the projected area A while the laser 13 is being projected on the metal powder 11, thereby allowing the metal powder 11 in the projected area A to be melted and sintered; the sintering thermal energy in the projected area A can be adjusted by adjusting the flow rate of the second gas 21; and the sintering thermal energy in the projected area A can be further adjusted by adjusting the angle at which the second gas 21 is applied and the temperature of the second gas 21. Therefore, the present disclosure is advantageous in that the thermal energy of the laser 13 projected on the metal powder 11 can be changed by changing the flow rate of the second gas passing through the projected area A, so as to perform metal three-dimensional printing with variable sintering thermal energy. Therefore, the present disclosure is applicable to technology of one single power laser source and yet is effective in changing sintering thermal energy.

What is claimed is:

1. A metal three-dimensional printing method with variable sintering thermal energy, comprising the steps of:
laying a layer of metal powder in a chamber, and the chamber having a first gas filled therein;
projecting a laser with one single power on the layer of metal powder along a predetermined path, thereby allowing the metal powder in a projected area to be melted and sintered for shape forming, applying a second gas at a predetermined flow rate on a surface of the metal powder in the projected area, and preventing the metal powder in the projected area from moving due to application of the second gas, wherein the second gas applied allows the metal powder being projected to be cooled;
during projection of the laser along the predetermined path, a cooling level of the metal powder being projected is changed by changing a flow rate of the second gas, thereby changing a sintering power of the metal powder,
wherein the first gas and the second gas are gases which cannot be oxidized.

2. The metal three-dimensional printing method with variable sintering thermal energy according to claim 1, wherein, in step B, applying the second gas further includes applying the second gas at a predetermined angle.

3. The metal three-dimensional printing method with variable sintering thermal energy according to claim 2, wherein the predetermined angle is variable.

4. The metal three-dimensional printing method with variable sintering thermal energy according to claim 1, wherein, in step B, applying the second gas further includes applying the second gas at a predetermined temperature.

5. The metal three-dimensional printing method with variable sintering thermal energy according to claim 4, wherein the predetermined temperature is variable.

6. The metal three-dimensional printing method with variable sintering thermal energy according to claim 1, wherein, in step B, the second gas to be applied is ejected from a nozzle, and a discharge hole of the nozzle is of a greater width than the projected area.

7. The metal three-dimensional printing method with variable sintering thermal energy according to claim 1, wherein the second gas and the first gas are identical.
